(19) United States
(12) Patent Application Publication
(10) Pub. No.: US 2022/0270021 A1
(43) Pub. Date: Aug. 25, 2022

(54) USER-CENTRIC SYSTEM FOR DYNAMIC SCHEDULING OF PERSONALISED WORK PLANS

(71) Applicant: Licorice App Pty Ltd, Adelaide (AU)

(72) Inventor: Samantha Glocker, Del Rio, TX (US)

(21) Appl. No.: 17/629,775

(22) PCT Filed: Jul. 27, 2020
(86) PCT No.: PCT/AU2020/050766

§ 371 Date: Jan. 24, 2022

(30) Foreign Application Priority Data
Jul. 25, 2019 (AU) 2019902658

(51) Int. Cl. G06Q 10/06

(52) U.S. Cl. CPC G06Q 10/063112; G06Q 10/063116; G06Q 10/063114

(57) ABSTRACT

A system for the dynamic scheduling of resources such as worker time to tasks such as IT support is disclosed. The system includes a client centric schedule availability interface for the scheduling of resources to a task, a worker centric schedule allocation interface for the display and management of tasks scheduled to a resource, and a worker centric active task interface for the display and management of tasks in progress. The scheduling and management of tasks and resources is enhanced by automation techniques utilising artificial intelligence solutions for the optimisation of functions performed through the interfaces.

### TECHNICAL FIELD

The field generally relates to scheduling systems for scheduling a task to a resource, in particular embodiments relate to the dynamic scheduling of resources to perform tasks. In particular; systems, methods and software applications comprising a task database and task interfaces.

### BACKGROUND OF THE INVENTION

Electronic calendaring systems, enabling a user to schedule a fixed period of time in a digital calendar and optionally invite other users to share and thereby coordinate the digital schedule, are almost ubiquitous. Digital calendaring systems enable users to coordinate a calendar schedule with groups of people, facilities and other resources.

In many fields, new work is generally unable to be scheduled in advance, for example, Information Technology (IT) support services and emergency health services. Consequently, new work is generally placed into a queue which is then able to be triaged and rearranged based on the criticality and urgency of the work.

However, unlike emergency health services which tend to critically urgent work, IT support service queues contain both urgent and critical work unable to be scheduled in advance, and requested or maintenance work which has more in common with the calendar-based systems of a medical clinic or doctors practice.

While medical clinics and doctor's practices typically use calendars to schedule their planned and maintenance appointments with patients, IT support services still overwhelmingly rely on a queue for all work, including requested and maintenance work. This total reliance on a queue for both emergency and regular work means IT support services are unable to offer online appointment booking for customers that many other industries (trades, beauty, medical, restaurants) already provide.

Within the IT industry a body of work is typically managed by putting a schedule of work (i.e. a task or Job) to be completed into a “ticket”. A series of tickets is then kept on a list. Each ticket will normally progress through a system of initial review or triage; during which additional information is gathered from other stakeholders if required. The ticket is then manually escalated from a lower level worker to a higher level worker appropriately skilled and available as required, to undertake the Job in a timely fashion, and will take into account a number of variables including:
priority (how urgent it is)
severity (the scope of its effect)
time estimate (how long the work is expected to take)
skill level (how difficult the work is expected to be).

The ticket is assigned to an IT professional, typically by adding it to their existing list of tickets, after which the IT professional will triage and manage the ticket.

In some environments such as in a hospital, or emergency services, the initial assessment of technical work is typically performed by a triage nurse or team lead. These individuals are often trained in the assessment and prioritization of upcoming work. However even in this scenario, this person must make fast and accurate assessments based on often changing variables, and missing information. This training can also be costly and impractical to scale to entire workforces; as would be required to adopt this practice for IT services.

The process of assessment and assignment is administratively intensive and often inaccurate. There are many variables (technical specifics, connected systems, security requirements, customer importance, effort estimates, required skill-level and experience, company and customer policies, availability of data, business impact) upon which a prioritisation decision must be made, which depend on the quality of the initial information gathered. This presents a difficult balance of time versus cost. Operators will seek to spend as little time as possible allocating and triaging the ticket before the actual work on the ticket has started.

The quality of assessment of each ticket is also highly dependent on the skills and experience level of the assessor, and their knowledge of the environment around them. Unlike a highly experienced triage nurse, frequently, the job of prioritising and assessing ‘tickets’ or similar Jobs is allocated to an entry-level technician, receptionist, junior, etc. Furthermore, the information provided to the assessor is incomplete and variables are constantly changing, sometimes very rapidly. All these factors introduce significant challenges in making triaging decisions.

When estimating the time allocation required for the completion of a task, workers are subject to optimism bias which is a belief that tasks in the future will not take as long as similar tasks took historically. A system which requires the estimation of effort by the worker is therefore also subject to optimism bias and will tend towards scheduled time allocations being underestimated in comparison to actual time spent on a task.

In the case of an IT ticketing system, deviations from the planned order of a ticket list occur with such frequent regularity that they are an accepted inadequacy of IT support services industry wide. Technicians typically handle deviations from their anticipated day manually by delaying follow on tickets such that their entire backlog of tickets also becomes delayed. Frequently, customers are expected to simply wait until IT gets to their ticket in the queue, however, on the infrequent occasions where customers do have a specific appointment time, the technician must further disrupt their day by trying to contact the customer to manually organise a new appointment.

In the IT services industry (unlike in the medical field where patients are seen on a prioritised need basis) IT technicians often have the freedom of control over when they start or finish an item on their ticket list. This can result in difficult or frustrating tasks being left on the list for long periods of time to become “stale”.

In the earlier scenarios, the inaccurate allocation and triage of tickets causes difficulties for both the technician and customer. The processes by which we derive the initial estimation for the required work are largely manual, and therefore are very time and cost intensive. Consequently, in many circumstances it is simply not cost-effective or practicable for humans to accurately predict the complexity of, duration of, and skills required to undertake a given piece of work, before the work commences, whilst also minimising time spent discovering those unknown factors about the work.

Many systems fall short of enabling the coordination of co-dependent or complex schedules. For instance, project managers must manage the scheduling of trades, skilled workers and resources whose outputs are dependent on one another, senior ward nurses must coordinate doctors, specialists and nursing staff with the urgency and complexity of patient needs, and technical workers must coordinate skills and available workers to meet the needs of their customers.

As workforces grow in size, work tasks management grows in near exponential complexity and the search to locate the right skills match for a given task grows with similar complexity. The increased complexity requires the assessment and assignment of tasks to be made accurately and at increasingly higher rates to maintain the efficiency of the system. This increase in rate of assessment and assignment leads to higher rates of human error, and in turn a reduction of customer satisfaction.

A system is therefore required which can schedule and allocate tasks accurately and rapidly in a scalable and robust way which preferably minimises error-prone human intervention.

### SUMMARY OF INVENTION

In a first aspect, embodiments of the invention relate to a scheduling system for scheduling a first task to an available resource having an available resource schedule defined by a first resource identification parameter and a first resource temporal parameter comprising;

a resource database configured to store data values associated with one or more resource schedules including at least a first resource identification data value associated with the first resource identification parameter and a first resource temporal data value associated with the first resource temporal parameter,
a task database configured to store data values associated with a first task including at least a first task identification data value associated with a first task identification parameter and a first task temporal data value associated with a first task temporal parameter,
a schedule availability interface for relating the task to the available resource wherein the schedule availability interface is configured to;
communicate a resource availability status for the one or more resource schedules comprising at least the first resource identification data value, the first resource temporal data value and one or more further resource temporal data values,
enable the creation of the first task in the task database by an input of the first task temporal data value associated with the first task temporal parameter received from the schedule availability interface, and
enable the modification of the first task in the task database by an input of a data value associated with the first task temporal parameter received from the schedule availability interface,
   a schedule allocation interface for allocating the first task to the available resource wherein the schedule allocation interface is configured to;
display a resource availability status for the available resource schedule displaying the first resource temporal data value associated with the first resource temporal parameter and a second resource temporal data value associated with a second resource temporal parameter,
enable the modification of the first task in the task database by an input of a data value associated with the first task temporal parameter received from the schedule allocation interface, and a communication of the data value to the task database, and
enable the allocation of the first task to an available resource by an input of a data value received from the schedule allocation interface, and a communication of the data value to the task database,
   an active task interface for tracking the temporal progression of an allocated task in-progress, wherein the active task interface is configured to;
enable the creation or modification of one or more active task progression temporal data values associated with an active task progression temporal parameter, and communicate the one or more data values to the task database,
reference the one or more task progression temporal data values with the first task identification data value within the task database, and
display the one or more active task progression temporal data values of the one or more tasks in-progress,
   wherein a first view comprises the schedule allocation interface and the active task interface in a single display.

As used herein the term “task” and any pluralisations and derivatives thereof, such as the terms “task based”, “task oriented” and the like, are to be understood to include within their meaning, but not be limited to, events, jobs and activities. Typically, a task will have a definable start and end of known or indeterminate length. Events may include festivals, functions, social gatherings, performances and the like regardless of the regularity of their occurrence as either one-off or recurring events. Jobs may include work-related tasks, household jobs, contractor jobs whether routine, repetitive or once-off in nature. Activities refer to actions that may be less defined in scope but nonetheless result in an output or outcome. Tasks may also be representations or descriptions by metadata of events, jobs and activities. These examples are intended to exemplify the intended definition rather than limit its constructions.

As used herein the term “resource” and any pluralisations and derivatives thereof, such as the terms “resourcing”, “resource pool” and the like, are to be understood to include within their meaning, but not be limited to, human resources, physical resources and intangible resources. Human resources may include groups, teams and individuals with specific skills, capabilities, know-how, or experience either collectively or individually. Physical resources include infrastructure such as buildings, facilities, critical infrastructure, specialised machinery or any other asset that may be amortised. Intangible resources may include direct access to or the ability to generate data, information, discoveries or other intellectual property. Resources may also be representations or descriptions by metadata of human resources, physical resources and intangible resources. These examples are intended to exemplify the intended definition rather than limit its constructions.

As used herein the term “parameter” and any pluralisations and derivatives thereof, such as the terms “parametric”, “parameterise” and the like, are to be understood to include within their meaning, but not be limited to, the characteristics by which a data record is defined or classified, and thereby which a data record can have operations performed thereon. Typically, a parameter will have a single data value associated per record such as an integer, a character, a string, a double, a date, and the like. The data value associated with a parameter may also contain a null value. In a relational database a parameter would be equivalent to a column header. These examples are intended to exemplify the intended definition rather than limit its constructions.

Embodiments comprise a database repository. The database repository may comprise a custom database, specifically created for the purpose of developing and deploying embodiments of the invention, or it may be a third-party repository. Third party database repositories may hold databases comprising data created by users of the present embodiments or by systems or software applications according to embodiments. Alternatively, they may hold databases comprising data created by third party systems or applications. In most instances however, it is anticipated that database repositories holding databases comprising data created by users of the present embodiments or by systems or software applications according to embodiments, are specifically created for the purpose of developing and deploying embodiments of the invention.

In preferred embodiments the resource database may be a custom relational database storing the metadata of resources. Other embodiments may comprise a non-relational or third-party integrated database solution which fulfils the same purpose. The resource database may be a standalone database, a table or collection of tables within a database, or integrated within a database used for other purposes.

In preferred embodiments the task database will be a custom relational database storing the metadata of tasks. Other embodiments may comprise a non-relational or third-party integrated database solution which fulfils the same purpose. The task database may be a standalone database, a table or collection of tables within a database, or integrated within a database used for other purposes.

As used herein the term “interface” and any pluralisations and derivatives thereof, such as “user interface”, “Application Programming Interface” and the like, are to be understood to include within their meaning but not be limited to, an interconnection between systems, equipment, components, and/or people. A “user interface” is the means of a user to interact with a system or software, and the means of the system or software to display the data required for the user to make a meaningful interaction therewith. An “Application Programming Interface” is the means for disparate systems or modules of a system to interconnect and make a meaningful interaction therewith. An interface may be a combination of both Application Programming Interface and user interface. These examples are intended to exemplify the intended definition rather than limit its constructions.

In preferred embodiments, user interfaces according to embodiments of the invention comprise a scheduling module. Preferred scheduling modules are configured to utilise data values held within the data repository. Such data values may relate to the availability of one or more resources, for instance workers having specific skills, equipment or facilities. The scheduling module is preferably configured to determine a period of time at which all required resources for a task are available. It may be preferably configured to display the availability of resources via the schedule availability interface.

In preferred embodiments, the user interface is configured to enable the user to select between times at which all required resources are available, and optionally, reschedule them if required.

The system may require many disparate items of information to make accurate and informed estimates on work time and complexity. In many cases, at the start of a task this reference information may either be incorrect or not knowable before the task commences. Thus, the system may continuously prompt for further information relating to:
a. The content of what the work is (not what it looks like, but what it is).
b. What questions to ask to properly assess the complexity and content of the work.
c. Knowledge of other systems connected to or associated with the work (what other secondary work might be connected to, or affected by, the primary work).
d. Knowledge of how long similar work took in the past (thereby how long the work might take).
e. The taxonomy of skills of each of the technicians around them (anywhere from a few, to several hundred people).
f. Whether there is an underlying cause of the work (i.e. the work is simply a symptom of an issue of greater severity or priority).
g. Whether the work has already been entered into the system elsewhere (possibly in a different way not easy to search or correlate).
h. Whether the work was recently completed and has come back again (and is possibly being reported by a different person who is unaware it has come back).
i. If any other pre-requisites must be met before the work can even commence, e.g.:
   i. Does the requestor have authority to ask for the work?
   ii. Should the work be billed, or is it included in a contract?
   iii. Are there other prerequisites (information, tools, or additional work) that need to be met before the work can be commenced?
   iv. Is the person requesting the work even who they say they are?

In preferred embodiments the schedule availability interface will be accessed for the selection of both a resource and an available resource schedule, which is suitable for the task being created. It may be accessed through a third-party application or through a custom user interface.

In preferred embodiments the schedule allocation interface will be accessed for the display and control of a worker's schedule availability in a day, week, or month layout. In further embodiments the schedule allocation interface may display a chronological list view or may display the schedule availability of multiple workers.

In preferred embodiments the active task interface will be accessed for the display of active tasks in progress and allow a worker to track the temporal expenditure and progress of active tasks. The active task interface will allow the worker to create and modify temporal data records associated with active tasks.

In preferred embodiments the schedule allocation interface and active task interface will be displayed in a side-by-side configuration.

As used herein the term “communicate” and any pluralisations and derivatives thereof, such as “communication” and the like, are to be understood to include within their meaning but not be limited to, the transmission, provision, transference, retrieval, deliverance, or copying of data from one module, component or interface to another module, component or interface. These examples are intended to exemplify the intended definition rather than limit its constructions.

As used herein the term “input” and any pluralisations and derivatives thereof, are to be understood to include within their meaning, but not be limited to, data received from outside of the system, module, or component which is receiving the data. It may take the form of user input, automated data collection, AI generated data, or the like. A single input may not only cover the input of a single piece of data but also a grouping of inputs intended to perform a single function such as double clicking, and clicking, dragging and releasing as a single action. These examples are intended to exemplify the intended definition rather than limit its constructions.

As used herein the term “view” and any pluralisation and derivatives thereof, are to be understood to include within their meaning, but not be limited to, a single display unit which displays and arranges one or more user interfaces in a meaningful and useful way. Views may include a worker view or a client view. These examples are intended to exemplify the intended definition rather than limit its constructions.

In a second aspect, further embodiments relate to a scheduling system according to the first aspect, wherein the first view comprises a schedule allocation interface and an active task interface characterised wherein:
the schedule allocation interface comprises a resource calendar for the resource displaying;
   regular time intervals wherein the resource availability status between each time interval is displayed as available or unavailable, and
   the first resource temporal data value and the second resource temporal data value which define a time interval in the resource calendar,
a first allocated task is displayed in the resource calendar across a time interval defined by;
   the first task temporal data value corresponding with a start time for the task, and
   a second task temporal data value corresponding with an end time for the task, and
   occupying all time intervals in the resource calendar therebetween, and
the active task interface comprises a display of tasks in-progress which include,
   one or more tasks associated with task temporal data values corresponding with a past start time for the task and a future end time, and
   one or more tasks associated with task temporal data values corresponding with a future start time and one or more active task progression temporal data values created from a user input via the active task interface,
      wherein the schedule allocation interface and the active task interface are linked to enable a user to dynamically create or modify one or more active task progression temporal data values with a single end user input.

As used herein the term “calendar” and any pluralisations and derivatives thereof are to be understood to include within their meaning but not be limited to, a chart, table, or other representation of a schedule in a visual format, covering a period of time. These examples are intended to exemplify the intended definition rather than limit its constructions.

In certain further embodiments according to the second aspect, the schedule allocation interface displays at least one sub-calendar configured to display one or more tasks sharing a common temporal data value.

In certain further embodiments according to the second aspect, the schedule allocation interface is configured to display a resource availability status for multiple resources whereby:
the schedule allocation interface comprises a resource calendar for the multiple resources displaying set time intervals wherein the resource availability status for each or all resources at a time interval is displayed as available or unavailable.

Further embodiments relate to a scheduling system according to the first aspect may be configured for viewing on a mobile device display, comprising a second view having a graphical user interface wherein the schedule allocation interface and the schedule availability interface are reduced or hidden, and the active task interface is displayed in the graphical user interface.

In a third aspect, embodiments of the invention relate to scheduling system for scheduling a first task to an available resource having an available resource schedule defined by a first resource identification parameter and a first resource temporal parameter comprising;

a resource database configured to store data values associated with one or more resource schedules including at least a first resource identification data value associated with the first resource identification parameter and a first resource temporal data value associated with the first resource temporal parameter,
a task database configured to store data values associated with a first task including at least;
a first task identification data value associated with a first task identification parameter,
a first task temporal data value associated with a first task temporal parameter, and
a first task request data value associated with a first task request parameter,
   a schedule availability interface for relating the task to the available resource wherein the schedule availability interface is configured to;
communicate a resource availability status for the one or more resource schedules comprising at least the first resource identification data value, the first resource temporal data value and one or more further resource temporal data values,
enable the creation of the first task in the task database by an input of the first task temporal data value associated with the first task temporal parameter and the first task request data value associated with a first task request parameter, received from the schedule availability interface, and
enable the modification of the first task in the task database by an input of a data value associated with the first task temporal parameter received from the schedule availability interface,
   a schedule allocation interface for allocating the first task to the available resource wherein the schedule allocation interface is configured to;
display a resource availability status for the available resource schedule displaying the first resource temporal data value associated with the first resource temporal parameter and a second resource temporal data value associated with a second resource temporal parameter,
enable the modification of the first task in the task database by an input of a data value associated with the first task temporal parameter received from the schedule allocation interface, and a communication of the data value to the task database, and
enable the allocation of the first task to an available resource by an input of a data value received from the schedule allocation interface, and a communication of the data value to the task database,
   an active task interface for tracking the temporal progression of an allocated task in-progress, wherein the active task interface is configured to;
enable the creation or modification of one or more active task progression temporal data values associated with an active task progression temporal parameter, and
communicate the one or more data values to the task database,
reference the one or more task progression temporal data values with the first task identification data value within the task database, and
display the one or more active task progression temporal data values of the one or more tasks in-progress,
   wherein a first view comprises the schedule allocation interface and the active task interface in a single display.

Further embodiments relate to a scheduling system according to the third aspect, wherein the schedule availability interface comprises a display enabled to create or modify the first task in the task database by an input of a categorised data value.

In a fourth aspect, further embodiments relate to a scheduling system according to the third aspect, wherein the task database is configured to;
store a set of historical task data values comprising one or more historical task request data values associated with a first task request parameter,
reference a first task request data value associated with a first task request parameter with the one or more historical task request data values associated with a first task request parameter, and
communicate the one or more historical task request data values with the schedule allocation interface wherein information of the one or more historical task request data values is displayed by the resource allocation interface.

Further embodiments relate to a scheduling system according to the fourth aspect, wherein the task database is configured to modify a first task request data value to categorise and associate the modified data value with a first task request parameter.

In a fifth aspect, further embodiments relate to a non-transitory computer readable storage medium having stored thereon an artificial intelligence engine for a scheduling system according to the fourth aspect, having a task processing artificial intelligence module configured to;
receive a task request from the schedule availability interface, and
process the request to generate a first task request data value,
   wherein the artificial intelligence engine is configured to process the task request to generate a first task request data value.

Further embodiments relate to a non-transitory computer readable storage medium according to the fifth aspect, wherein the task processing artificial intelligence module comprises a natural language processing tool.

Artificial Intelligence assisted systems have the ability to democratise the task-worker matching process, but they also enable the customer to become empowered in the activity of scheduling. AI assisted systems may enable the timely and accurate identification of work requirements and/or additionally alleviate the scheduling burden borne by service providers as they may be facilitated, in large part, by the end user or customer.

As used herein the term “artificial intelligence” and any pluralisations and derivatives thereof, are to be understood to include within their meaning the definition as per the United States Future of Artificial Intelligence Act of 2017, section 3; that being, that artificial intelligence includes any artificial systems that perform tasks under varying and unpredictable circumstances, without significant human oversight, or that can learn from their experience and improve their performance. Such systems may be developed in computer software, physical hardware, or other contexts not yet contemplated. They may solve tasks requiring human-like perception, cognition, planning, learning, communication, or physical action. In general, the more human-like the system within the context of its tasks, the more it can be said to use artificial intelligence. Systems that think like humans, such as cognitive architectures and neural networks. Systems that act like humans, such as systems that can pass the Turing test or other comparable test via natural language processing, knowledge representation, automated reasoning, and learning. A set of techniques, including machine learning, that seek to approximate some cognitive task. Systems that act rationally, such as intelligent software agents and embodied robots that achieve goals via perception, planning, reasoning, learning, communicating, decision making, and acting.

As used herein the term “module” and any pluralisations and derivatives thereof, such as “artificial intelligence module”, “task correlation module” and the like, are to be understood to include within their meaning, but not be limited to, discrete units which are interrelated to form a more complex system. Modules may be generally defined such as “networking module” or “data storage module” or may be more narrowly defined such as “time tracking module” or “user preferences module”. These examples are intended to exemplify the intended definition rather than limit its constructions.

In preferred embodiments, artificial intelligence modules of the invention comprise a task content identifier, a task time estimator, a task correlator, resource-based routing and/or other task related functions.

The task content identifier may comprise a natural language processing algorithm, optionally, in communication with a text-based task request prompt embedded within the user interface. The natural language processing algorithm is preferably configured to discern the semantic intent of the task request and thereby determine the task requirements. In alternative embodiments however, the task content identifier may utilise third party applications to input a task request and therefore may comprise an Application Programming Interface to integrate with third party systems.

In preferred embodiments of the invention, data outputs from the task content identifier are held within the database repository. The data outputs may be utilised by the task correlation module.

The task content identifier may not only determine any number of task requirements but also any number of task characteristics. For instance, the task content identifier may be configured to ascertain the urgency of the task. Task requirements and/or task characteristics may be held within the database repository. Task requirements and/or task characteristics may be metadata associated with the task request.

Artificial intelligence modules according to embodiments may be configured to provide machine learning capabilities. These may include machine learning techniques that improve the accuracy of determining task requirement and/or task characteristics.

In preferred embodiments, task correlation modules of the invention comprise a resource-based routing algorithm and/or machine learning capability.

Resource-based routing algorithms according to embodiments of the invention are preferably applied to outputs of the task content identifier. Preferably, the resource-based routing algorithm references the outputs of the task content identifier with data held within the database repository. For instance, data relating to previous tasks may be held within the database repository whereby the resource-based routing algorithm links or matches the output of the task content identifier with this data to determine the similarity of the tasks. This may be used to determine characteristics of the task such as the estimated task time or the identity of workers who may have performed similar tasks in the past.

Preferred resource-based routing algorithms may utilise data relating to resources. Resources may be available resources or resources that may become available at a later time, and may include skills, consumables, infrastructure or intangible resources. In particular, non-human resources may include parts and equipment; for instance, hardware, cables, medical apparatus, cranes and other heavy machinery, diagnostic equipment and the like. Metadata relating to resource characteristics, such as number, size or availability may be associated with the resource. This data and/or associated metadata is preferably held within the database repository.

Preferred resource-based routing algorithms comprise skills-based routing algorithms, which preferably determine the discrete skills available among a group of workers. A task correlation module preferably utilises resource-based routing algorithms, such as skills-based routing algorithms, to match resources such as workers with tasks.

In more complex scenarios, preferred resource-based routing algorithms may match more than one resource with a task. For instance, a piece of equipment and a worker with dual skills in the operation of the equipment and the performance of the task may be matched with the task. In particular, two or more resources may be required to fulfil the required task. For instance, a team with each member contributing a different required skill may be required; with or without specific equipment or other non-human resources. Thereafter, all resources may be scheduled in accordance with their availability.

Task correlation modules may further comprise machine learning capabilities to optimise the accuracy and/or performance of the resource-based routing algorithm. Machine learning techniques may be applied to historical information of the time taken for the performance of tasks, the return rate of individual tasks or any one of a vast number of feedback data points.

In preferred embodiment, systems according to the fifth aspect may comprise multiple machine-learning systems, either working independently, or together, to determine any one or, or a combination of:
a. What the task content is (the meaning of the task), as described by a human in plain language.
b. Whether the task request was generated by an automated system, for example:
   i. An automated monitoring system (or “remote monitoring and management”, “RMM”)
   ii. An alert from a device (e.g. a backup device, a power device, a hardware monitoring device)
   iii. A temperature alarm, a moisture gauge, a computer-generated alarm or similar sensors or devices
   iv. An out-of-office autoreply
   v. An unsolicited or ‘spam’ system
   vi. The task request was generated by a human
   vii. The task request was generated by an automated system but forwarded by a human.

The artificial intelligence capability determines which questions were asked on previously completed tasks and suggests questions that may need to be asked for this type of task. There may be a setup screen where admins of the software can fine-tune the suggested questions asked, or other questions that might be appropriate to ask about the work.

Artificial intelligence modules may also be configured to determine:
a. What sub-tasks would be helpful to completing the task to a required standard.
b. Whether the task requires a worker to undertake an on-site visit or whether it can be performed remotely.
c. Whether the task is correlated with any previous task, and in what way it is correlated, for example:
   i. Is it the same task for the same customer?
   ii. Is it the same task for a different customer?
   iii. Is it a similar task for the same customer?
   iv. Is it a similar task for a different customer?
d. Whether the task is a symptom, and there is an underlying root-cause.
e. The duration of the task based on similar tasks performed in the past.
f. Which workers are good at certain types of work (often called a “Skills Matrix”)?
g. And consequently, which workers might be best suited (or required) to complete this work (often called “Skills-based Routing”).
h. Any other metrics required to ensure the work is completed to a required standard.

In a sixth aspect, embodiments of the invention relate to a scheduling system for scheduling a first task to an available resource having an available resource schedule defined by a first resource identification parameter and a first resource temporal parameter comprising; a resource database configured to store data values associated with one or more resource schedules including at least;
a first resource identification data value associated with the first resource identification parameter,
a first resource temporal data value associated with the first resource temporal parameter, and
a first resource capability data value associated with a first resource capability parameter,
   a task database configured to store data values associated with a first task including at least a first task identification data value associated with a first task identification parameter and a first task temporal data value associated with a first task temporal parameter,
   a schedule availability interface for relating the task to the available resource wherein the schedule availability interface is configured to;
communicate a resource availability status for the one or more resource schedules comprising at least the first resource identification data value, the first resource temporal data value and one or more further resource temporal data values,
enable the creation of the first task in the task database by an input of the first task temporal data value associated with the first task temporal parameter received from the schedule availability interface, and
enable the modification of the first task in the task database by an input of a data value associated with the first task temporal parameter received from the schedule availability interface,
   the resource database further configured to;
filter or prioritise multiple resources according to their resource temporal data values associated with their resource temporal parameters and their capability data values associated with their capability parameters, according to preferences or criteria pre-set within the database or preferences or criteria selected from the schedule availability interface,
communicate a resource availability status for the filtered or prioritised resources each comprising at least one resource identification data value and two or more resource temporal data value and one or more further resource temporal data values
   a schedule allocation interface for allocating the first task to the available resource wherein the schedule allocation interface is configured to;
display a resource availability status for the filtered or prioritised resources displaying the first resource temporal data value associated with the first resource temporal parameter and a second resource temporal data value associated with a second resource temporal parameter,
enable the modification of the first task in the task database by an input of a data value associated with the first task temporal parameter received from the schedule allocation interface, and a communication of the data value to the task database, and
enable the allocation of the first task to an available resource by an input of a data value received from the schedule allocation interface, and a communication of the data value to the task database,
   an active task interface for tracking the temporal progression of an allocated task in-progress, wherein the active task interface is configured to;
enable the creation or modification of one or more active task progression temporal data values associated with an active task progression temporal parameter, and
communicate the one or more data values to the task database,
reference the one or more task progression temporal data values with the first task identification data value within the task database, and
display the one or more active task progression temporal data values of the one or more tasks in-progress,
   wherein a first view comprises the schedule allocation interface and the active task interface in a single display.

Further embodiments relate to a scheduling system according to the sixth aspect, wherein the resource database configured to store data values associated with the one or more resource schedules further includes at least;
a first resource identification data value associated with the first resource identification parameter,
a first resource temporal data value associated with the first resource temporal parameter,
a first resource capability data value associated with a first resource capability parameter, and
a first resource feedback data value associated with a first resource feedback parameter,
   and the resource database is further configured to;
   filter or prioritise multiple resources according to their resource feedback data value associated with a first resource feedback parameter and resource temporal data values associated with their resource temporal parameters and their capability data values associated with their capability parameters, according to preferences or criteria pre-set within the database or preferences or criteria selected from the schedule availability interface.

In a seventh aspect, further embodiments relate to a scheduling system according to the sixth aspect, wherein the schedule availability interface and the schedule allocation interface are configured to rank or weight;
preferences or criteria pre-set within the database, or
preferences or criteria selected from the schedule availability interface
   to prioritise the scheduling of resources with preferred resource data values associated with selected resource parameters.

Further embodiments relate to a scheduling system according to the seventh aspect, wherein the selected resource parameters comprises a resource feedback parameter including any one of; the time taken for completion of the task, number of times a task has been reopened, a satisfaction score, number of the same or similar tasks previously completed, or any combination thereof.

Further embodiments relate to a non-transitory computer readable storage medium having stored thereon an artificial intelligence engine for a scheduling system according to the seventh aspect having a resource processing artificial intelligence module configured to;
prioritise the scheduling of resources with preferred resource data values associated with selected resource parameters,
communicate one or more prioritised resource schedules to the schedule allocation interface, and
   receive resource feedback data values to modify the resource processing artificial intelligence module.

In an eighth aspect, further embodiments relate to a scheduling system according to the seventh aspect, wherein the task database is configured to store data values associated with a first task including at least;
a first task identification data value associated with a first task identification parameter,
a first task temporal data value associated with a first task temporal parameter, and
a first task request data value associated with a first task request parameter, wherein the first task request data value is categorised and referenced to any one of a resource identification data value, resource temporal data value, resource capability data value or a resource feedback data value.

Further embodiments relate to a scheduling system according to the eighth aspect, wherein the schedule availability interface comprises a display enabled to create or modify the first task in the task database, by an input of a categorised data value, and referenced to any one of a resource identification data value, resource temporal data value, resource capability data value or a resource feedback data value.

Further embodiments relate to a scheduling system according to the eighth aspect, wherein the artificial intelligence engine comprises a task processing artificial intelligence module configured to;
receive a task request from the schedule availability interface, and
process the request to generate a first task request data value,
   wherein the artificial intelligence engine is configured to process the task request to generate a first task request data value that is categorised and referenced to any one of a resource identification data value, resource temporal data value, resource capability data value or a resource feedback data value.

As used herein the term “real time” and any pluralisations and derivatives thereof, are to be understood to include within their meaning, but not be limited to, a state of affairs in which data is processed as it enters the system and is propagated through each dependent component as soon as the system is able, to henceforth be represented in dependent elements displayed on client devices. This example is intended to exemplify the intended definition rather than limit its constructions.

In a further aspect, embodiments of the invention relate to methods for scheduling resources required to perform at least one task. Methods according to this aspect preferably include the steps of;
utilising an artificial intelligence module for determining the requirements of a task request,
using a task correlation module for matching resources with the requirements of the tasks, and
displaying the availability of resources for performing the task upon a user interface.

Preferably, methods include the further steps of;
receiving a task request from a user via a user interface,
utilising an artificial intelligence module for determining the requirements of the task request,
maintaining task request data within a database repository,
maintaining resource data within a data repository,
using a task correlation module for matching the resource data with the requirements of the tasks, and
displaying the availability of resources for performing the task upon the user interface.

Accordingly, in preferred methods the step of utilising an artificial intelligence module for determining the requirements of the task may include the additional steps of;
applying a task content identifier to the task request, and optionally
applying a task time estimator to the request.

In preferred methods, the step of using a task correlation module for matching the resource data with the requirements of the task may include the additional steps of;
applying a resource-based routing algorithm to the resource data, and optionally
applying the resource-based routing algorithm to the request data.

Preferably the steps of using resource-based routing, include the additional step of matching, ranking or optimising task request data with resource data.

Preferred methods involving the use of the task correlation modules further include the step of applying machine learning techniques to the resource-based routing algorithm.

Preferred methods involving the step of displaying the availability of resources, involves the use of a schedule availability interface to determine a period of time at which all required resources meeting the requirements of the task request are available. Methods may further include the optional step of selecting between times at which all required resources are available, and optionally, reschedule them via the user interface.

In alternative embodiments of the invention, software applications for scheduling resources required to perform at least one task comprise;
an artificial intelligence module, and
a task correlation module
   wherein the software application is configured to be executable on a device to display a user interface.

Artificial intelligence modules according to alternative embodiments comprise a task content identifier, a task time estimator and/or other task related units. In particular, they may comprise units capable of executing machine learning techniques. Accordingly, the software applications may be configured to improve the accuracy of determining task requirement and/or task characteristics.

In further embodiments, devices may be configured in accordance with alternative embodiments provided above. Additionally, embodiments of the invention relate to devices configured to deploy methods according preferred embodiments.

This invention effects environments where any technical work is being completed on a regular or ad-hoc basis. Where the work is initiated either by a customer or a technician. Where the environment relies on fixed appointment scheduling (such as in the medical industry) where blocks are allocated in “single”, or “double” appointments. Or where work is carried out in a list, or queue, style system (such as in the IT industry).

The invention now will be described with reference to the accompanying drawings together with the Examples and the preferred embodiments disclosed in the detailed description. The invention may be embodied in many different forms and should not be construed as limited to the embodiments described herein. These embodiments are provided by way of illustration only such that this disclosure will be thorough, complete and will convey the full scope and breadth of the invention.

### BRIEF DESCRIPTION OF THE FIGURES

FIG. 1 provides a flow diagram illustrating a software topology in accordance with embodiments of the invention.

FIG. 2 provides a flow diagram illustrating a method of creating a new task from the perspective of the client, according to embodiments of the invention.

FIG. 3 provides a schematic representation showing a pattern for assigning work to technicians in accordance with embodiments of the invention.

FIG. 4 provides a schematic representation showing a pattern for determining jobs that are correlated to newly entered work into the system in accordance with embodiments of the invention.

FIG. 5 provides an overview of a worker's schedule together with their team schedule, in a view comprising embodiments of the schedule allocation interface and the active task interface.

FIG. 6 provides an example of a schedule availability interface according to embodiments of the invention.

FIG. 7 provides an example of a worker's active task interface on a mobile device, according to embodiments of the invention.

### DESCRIPTION OF EMBODIMENTS

Several embodiments of the invention are described in the following examples.

Tables 1 and 2 below provide a comparison of an example day which has been scheduled by methods typical in the prior art. Table 1 illustrates a planned day consisting of both single length and double length appointments scheduled by a worker in a typical appointment booking system.

Table 2 illustrates an example of how the day plays out in contrast to the scheduled day. The appointments rarely run to the scheduled time and the worker needs to adjust the schedule, and work during their own time to make up for the discrepancies.

This scenario is typical for settings in which tasks are assigned in appointment blocks such as is typical in the medical industry. In this environment, task completion schedules typically deviate from their allocated schedule due to an underestimation of the time required to complete the task or as a consequence of an unexpected event (in a medical setting this may arise from the occurrence of a medical emergency).

TABLE 1
Example of scheduled day according to prior art methods

| Time | | Scheduled Day |
|---|---|---|
| 9:00 | AM | Single Appointment |
| 9:30 | AM | Single Appointment |
| 10:00 | AM | Double Appointment |
| 10:30 | AM | |
| 11:00 | AM | Single Appointment |
| 11:30 | AM | Single Appointment |
| 12:00 | PM | Lunch |
| 12:30 | PM | |
| 1:00 | PM | Single Appointment |
| 1:30 | PM | Double Appointment |
| 2:00 | PM | |
| 2:30 | PM | Single Appointment |
| 3:00 | PM | Single Appointment |
| 3:30 | PM | Single Appointment |
| 4:00 | PM | Single Appointment |

TABLE 2
Example of actual day according to prior art methods

| Time | | Actual Day |
|---|---|---|
| 9:00 | AM | Single Appointment |
| 9:40 | AM | Single Appointment |
| 10:15 | AM | Double Appointment |
| 10:30 | AM | |
| 11:00 | AM | Single Appointment |
| 11:20 | AM | Single Appointment |
| 12:00 | PM | |
| 12:20 | PM | Lunch |
| 1:00 | PM | Single Appointment |
| 1:25 | PM | Double Appointment |
| 2:00 | PM | |
| 2:20 | PM | Single Appointment |
| 3:00 | PM | |
| 3:20 | PM | Single Appointment |
| 3:55 | PM | Single Appointment |
| 4:25 | PM | Single Appointment |

The following lists similarly provide a comparison of an example day whereby the worker has planned their day according to a series of sequential tasks, with only a single scheduled task through the day, utilising a ticket system typical to the prior art.

### Planned Day:

Ticket 1
Ticket 2
11:30 Scheduled Ticket 3
Ticket 4
Ticket 5

### Actual Day:

New Urgent Ticket A
New Urgent Ticket B
Ticket 4 Became More Urgent
New Urgent Ticket C
New Urgent Ticket D
16:30 Get to Scheduled Ticket

The planned day list illustrates the plan by a worker to complete five ticketed tasks, four of which are able to be completed at any time, and one of which has been scheduled for commencement at 11:30.

The actual day list illustrates how the day plays out in contrast to the scheduled day. The day is filled with new tasks which are deemed to require immediate attention and the escalation of a ticket to urgent, while the scheduled task gets delayed until late in the day.

This scenario is typical for settings in which the content and requirements of a task are largely uncertain until the task is commenced, such as in the IT support industry. In the event that a scheduled task requires more time than expected to complete, or an emergency arises, it is common for the technician to continue working on that ticket until resolution, disregarding all other work. If it is deemed that the task will take too long, or there is a more appropriate resource, the technician may reschedule or re-assign the work to a different resource to align their actual day more closely with the planned day.

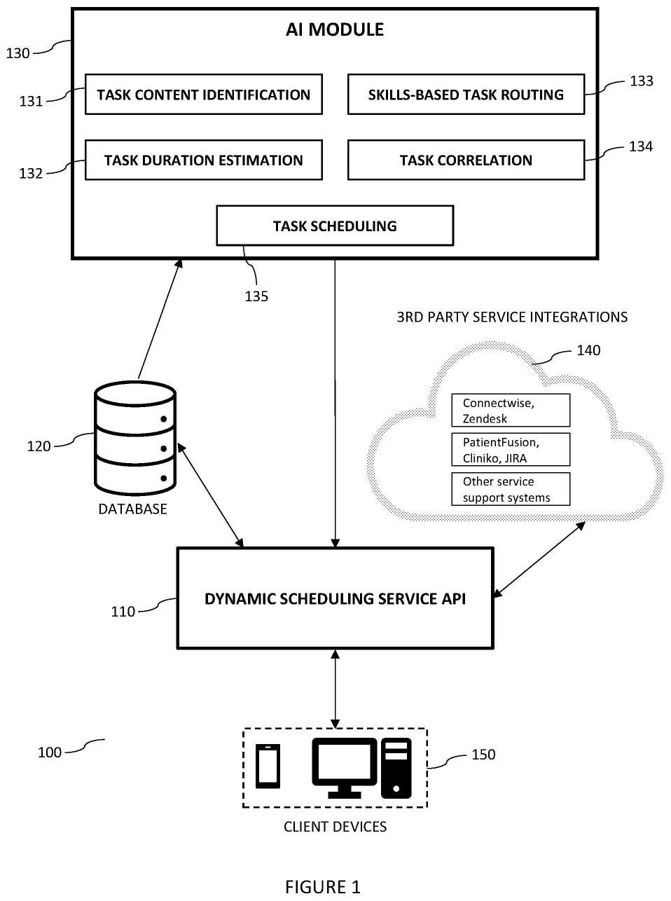

FIG. 1 provides a software topology of an embodiment of the invention whereby data is communicated between each component of the embodiment via a network such as the internet, a mobile network, or other networks known to those skilled in the art.

System 100 comprises a Dynamic Scheduling Service Application Programming Interface (API) 110, a Database 120, an Artificial Intelligence (AI) Module 130 which further comprises a Task Content Identification Module 131, a Task Duration Estimation Module 132, a Skills-Based Task Routing Module 133, a Task Correlation Module 134, and a Task Scheduling Module 135. The System 100 further comprises one or more Third Party Service Integrations 140, and one or more Client Devices 150.

Data is communicated and updated to each component in real time as the end user makes changes to information within the System 100. The data transfer and the user interaction is handled by a combination of a software application and the Dynamic Scheduling Service API 110.

The Dynamic Scheduling Service API 110 may be a PHP REST API accessible by the one or more Client Devices 150. In alternative embodiments the Dynamic Scheduling Service API 110 may be a SOAP API or other API types which operate using communication protocols including HTTP, SMTP, TCP or others known to those skilled in the art and may be called by the one or more Client Devices 150 directly, or by the use of remote procedural calls. In preferred embodiments the Dynamic Scheduling Service API 110 will be in direct communication with the Database 120 and will access the data values thereon.

The software application may be accessible through the Client Device 150 such as through a web browser on a conventional desktop or laptop device, or through a native application installed on a smart device such as a mobile phone or tablet. The Client Device 150 communicates with the Dynamic Scheduling Service API 110 through its networking hardware via the network. The Dynamic Scheduling Service API 110 may be accessible online through a third-party platform such as Microsoft Azure or Amazon AWS or may be self-managed in an on-premises configuration.

The Third-Party Service Integrations 140 may come from other cloud based or Software as a Service (SaaS) providers. These may include, but are not limited to, Zendesk, ConnectWise, and others known to those skilled in the art. Additional integrations may optionally allow for bulk upload of file formats specified by the API Documentation. A number of integrations well known to those skilled in the art may be facilitated by exposing API endpoints that third parties can integrate with directly. This flexibility allows for end-users to configure automatic systems or devices to make requests on behalf of the end-user without user interaction.

The implementation of Database 120 may be relational in nature, leveraging known frameworks such as SQL. The implementation data may be stored in a non-relational database such as MongoDB, or data may be stored in a combination of configurations to maximize real time data processing. The Database 120 may be a single database or multiple databases containing portions of the required stored information.

The Database 120 is accessed through an API service which facilitates authentication, business logic and routes information between the disparate components (or modules) of the given system. The Database 120 is responsible for providing the dataset required for operation of the system by the end user as well as providing reference and metadata for the AI Module 130 to learn and decipher next actions.

In addition to storing data related to tasks, such as title, description, tags, users, and associated AI metadata, the Database 120 is responsible for storing and managing both client and worker information, as well as information related to other resources.

An organisation can add its workers into the system. Resulting in the data being stored inside the Database 120. In preferred embodiments this data comprises:
a. Names
b. Emails
c. Titles
d. Phones
e. Security Role
f. Start and finish time override
g. Time-zone override
h. User status (active/billed, inactive/unbilled)

A valid organisation is required within the system. The metadata required for a valid organisation to be stored in the Database 120 comprises:
a. Organisation name
b. Organisation domain name
c. System URL
d. Organisation main phone number
e. Default workday (start and finish times)
f. Default time zone
g. Default time rounding

Information about the user stored in the Database 120 comprises:
a. User profile picture
b. Name
c. Email address
d. Phone number

Teams can optionally be set up which provide a link between the identifier of an organisation(s) and the identifier of a worker(s).

Setting up Third Party Service Integrations 140 requires additional information. This information is also stored in the Database 120 and may include properties such as:
a. Integration URL
b. Integration Key
c. Provider Endpoints/Triggers
d. Consumers of Alerts/Triggers

User accounts, whether via organisation or individual may also be associated with related billing data in the Database 120, including:
a. Subscription status
b. Credit card information
c. Access invoices, tax, billing history

Tasks can be entered into the database via two methods. Through end user input or through a Third-Party Service Integration 140, which is managed by the API layer. A task may contain several different values or be derived from the relationship between several tables in the database. The following describes relations necessary to define a task in a given embodiment.

Workers may record multiple time entries against a given task, each time entry will need to capture data including:
a. Billable Status (Billable vs. Non-Billable)
b. Related Note(s) Public
c. Related Note(s) Private
d. Related Resource(s) (Workers)

A task may also require industry-specific metadata. For example, within the IT Industry a task may record:
a. Priority
b. Severity
c. Estimated Time
d. Estimated Budget
e. Target Completion Date
f. Task Category
g. Task Sub-Category
h. Associated Task(s) required to close ticket
i. Industry Agreement/Contract

The Dynamic Scheduling Service Application Programming Interface (API) 110 layer is the central hub for communication between the elements of an embodiment. Typically, in service-based architectures the API layer is responsible for performing and validating core business functions across a given product. It is also responsible for transforming data from the disparate elements of the system so that each system can consume the data in its required format, as well as authentication, billing and associated business functions.

The Dynamic Scheduling Service API 110 (in conjunction with a Client Device 150) may automate manually intensive tasks. One such task is time tracking. The Dynamic Scheduling Service API 110 automatically starts tracking time on behalf of a worker given several parameters. In the most basic form, a worker's time is tracked for the day once their scheduled day starts in the system. In cases where their day differs from the normal routine, due to sickness or otherwise, the worker can manually correct the discrepancy.

When a worker opens an application enabling the system, on a Client Device 150 such as a smart phone or similar, the system will detect if it is the first login of the day or is likely to be the last login of the day (given proximity to the worker's preferred start and end time). In this instance, the worker is prompted to manually start or stop tracking their time for the day.

The API may also detect when a worker has arrived at work. This interaction is facilitated via a smart device such as a mobile or tablet connected to GPS utilising a technique for geofencing know to those skilled in the art. An organisation may create optional rulesets, which define where and how workers can begin their workday. For example, a worker may be required to start their morning in the office and so to qualify for time tracking for the day they may be required to be at their place of work to trigger geofencing and start time tracking. Alternatively, workers who work from home, or start their day from home, may be able to designate an alternate start location that allows them to successfully start time tracking for the day through geofencing at the approved location.

The worker may be required to provide biometric data in order to start or stop tracking time in industries where security and compliance are a priority.

In each of the above instances, workers can edit their tracked time, for example, to pause the tracking for their designated break.

In addition to automated time tracking providing a solution to the costly and manual exercise of managing and scheduling work, the tracker also provides an accurate and robust solution for empowering payroll and associated business services to correctly bill and renumerate users of their system.

As a result of the extra data generated from the AI Module 130, the Dynamic Scheduling Service API 110 layer is also able to generate automatic reports to support other business requirements, such as client reporting or internal accounts reporting.

For example, traditionally a skills matrix would be generated by a given technician based upon the skills they believe they possess or are accredited for. In an AI driven solution like the present solution, a skills matrix is derived from data within the system and provides a true reflection of a technician's actual capability rather than perceived capability. Such analyses are also determined as being relative to a worker pool, such that the best capabilities available can also be determined using the AI Module 130. A report providing this information can be quickly and accurately derived by investigating information including:
a. Which workers' tasks are resolved properly the first time?
b. Which workers don't close their tasks properly?
c. Workers who over-book their time each day.
d. Workers who are extremely organised and keep to their schedule.
e. Most efficient workers (by tasks completed per day, including accounting for task complexity).
f. Least efficient workers.
g. Most skilled workers.
h. Least skilled workers.

The reporting system may also be able to recognise and report patterns across industries. For example, property managers may consistently require assistance with problematic air conditioners in summer.

For industries in which typical tasks vary in duration, systems may be able to aggregate, anonymise and produce data that may be challenging to ascertain norms due to the siloing of information. For example, reports may be generated and published that could disclose:
a. The average time to complete “X” type of task.
b. Average time to complete “Y” type of task.
c. Average number of tasks closed per day by worker type.
d. Average number of tasks closed per day by client industry.
e. Average delay to schedule a task (i.e. can most tasks be scheduled right away, or are end-users having to schedule tasks a week out?).
f. Average number of times tasks are rescheduled.
g. Whether a worker reduces task time allowances but consistently exceeds those reduced times.

Third Party Service Integrations 140 enable the transfer of initial data that is required to train the AI systems to accurately perform their processes. As AI systems typically require large data sets from which to learn, and many potential users providing services will already be utilising existing third-party services, such as Zendesk or ConnectWise.

These integrations perform a dual role. Firstly, they allow users to seamlessly move from manual, non-AI assisted workflows to a service that allows for AI backed decision making. Secondly, the integrations provide important historic dataset from which to begin machine learning, either relative to an industry or to a specific organisation.

Third Party Service Integrations 140 also provide a benefit in reducing the manual cost of task scheduling. As the Internet of Thing (IoT) progressively becomes more pervasive, and systems are engineered to be largely automatic; by consuming or by providing public facing APIs third party system may automatically integrate with the present systems or applications. This alleviates the need for human intervention or unreliable processes to automate what is otherwise a time intensive task.

The Artificial Intelligence Module 130, and its corresponding components and rulesets may be developed via proprietary algorithms. The AI Module 130 may consume third party Software as a Service (SaaS) platforms. These services may include, but are not limited to, Natural Language by Google (https://cloud.google.com/natural-language/) or the Language Cognitive Services API by Microsoft (https://azure.microsoft.com/en-au/services/cognitive-services/directory/lang/).

The Artificial Intelligence Module 130

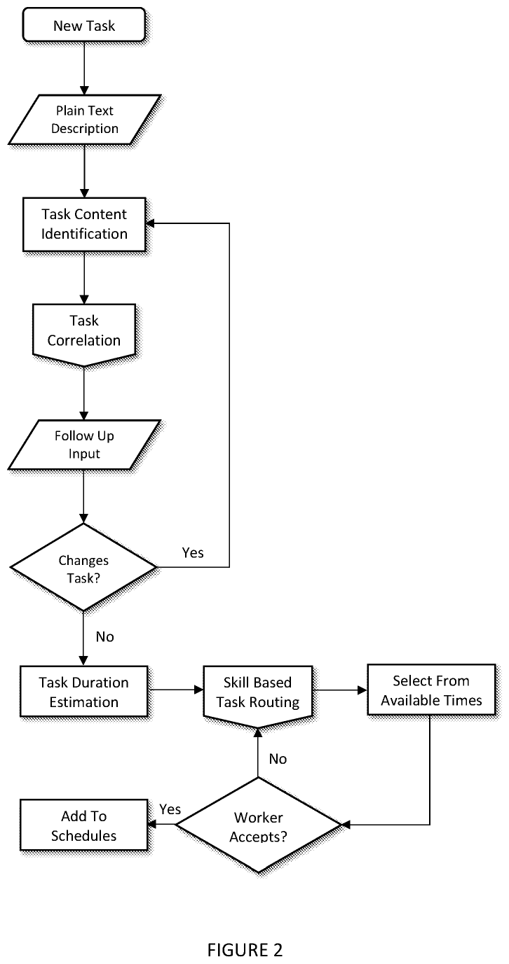

FIG. 2 illustrates a typical workflow for an embodiment of the system, which commences with the client accessing a user interface of the system or a third party system to begin creating a new task. The client then enters a plain text description of the task and submits the entered details to the system.

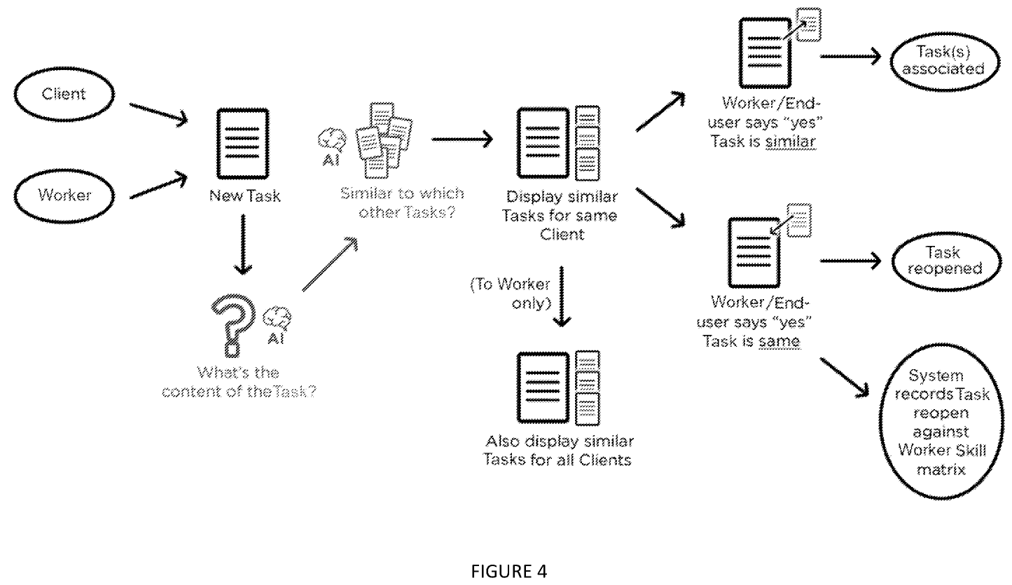

The details of the task as entered by the client are comprehended by natural language processing algorithms and the Task Content Identification Module 131 identifies the content and requirements of the task. The Task Correlation Module 134 then accepts the output of the Task Content Identification Module 131 to find other tasks which may be the same or similar, further illustrated in FIG. 4.

Based on the outputs of the Task Content Identification Module 131 and the Task Correlation Module 134, the system presents relevant follow up questions to the client and accepts further input to verify the nature of the task. While the further input changes the nature of the task, the content identification and task correlation steps are repeated with new input being accepted.

Once the nature of the task is verified, the task progresses to the Task Duration Estimation Module 132 where the amount of time required to complete a task is estimated by the AI system based on historical data. This may consider any required travel time and apply this to the total.

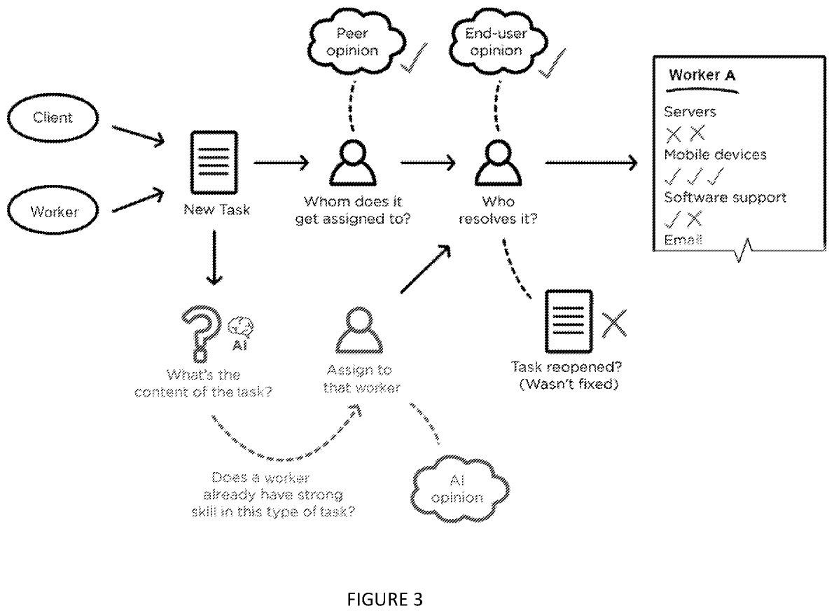

The Skills-Based Task Routing Module 133 finds suitable workers in a process further illustrated in FIG. 3 and allows the client to select an available time which is suitable for both the client and a worker. The worker is then presented with the option to accept or reject the task. If the worker rejects the task, then the Skills-Based Routing Module 133 presents other workers and times to the client to select.

Once a worker has accepted the task it is added to their schedule and displayed on their calendar to be managed.

In certain embodiments the AI Modules 131 to 135 may be discrete and working in isolation. However, in other embodiments, they may serve a dual function or be implemented in a larger service. For example, the Task Correlation Module 134 and Task Content Identification Module 131 may both be engineered from the same natural language processing code, however simply applying different rulesets.

Embodiments function by leveraging AI and Machine Leaning (ML) from real time data captured within the Database 120, to create accurate assessments of plain language requirements for work from either technicians or clients. Each of the components of the AI Module 130 are described in further detail below.

AI Module 130 is deployed in five key areas:
a. Task Content Identification 131
b. Task Duration Estimation 132
c. Skills-based Task Routing 133
d. Task Correlation 134
e. Task Scheduling 135

While these modules may be discrete, interrelationships therebetween may be required for data flow and functionality in preferred embodiments.

FIG. 3 illustrates the typical workflow for a skills-based task routing system, which commences with an AI Module 130 receiving a new task. The Task Content Identification Module 131 attempts to classify the content of the work which is facilitated by multiple points of data collected from the user, these include the title and description of the work as well as any tags that might apply to the given work. Natural language processing algorithms are applied to the description and a title of the new task; in order the discern the semantic intent behind the Task request (i.e. what the work requirement actually involves). The natural language processing assists in understanding task content and determining the task requirements, for example, skills requirements and time required to complete the task.

In addition to analysing task title and description, the AI Module 130 infers from the source of the request whether the item has been generated by a user, was automatically created by a third party service or was a notification from an Internet of Things (IoT) device. The source of the request in combination with the analysis of the natural language provided in the task help to determine the type of task as well as its urgency. For example, an automatically generated ticket from a third-party system may be marked as a “some-time today” task with a low priority because the same ticket has been seen regularly and routinely takes less than five minutes to complete. Conversely, if the system recognises the source of a task request as a person via their logged in email address and is able to identify phrases such as “urgent” it may instead schedule it as a regular task and attempt to put it in the earliest timeslot available.

The AI Module 130 also attempts to find other tasks which have similar characteristics to the current task. At the task Identification stage, the Task Correlation Module 134 references tasks with similar characteristics to provide some certainty (or opinion) on the work content by comparing how closely it matches other work in the system, as illustrated by FIG. 4. The more certain the system is about a task's related-ness to another, the better it can provide a more accurate expectation of time for completion and recommend the best technician(s) for the task.

Assisting with the accurate identification of work content, the AI system may utilise special mark-up symbols in the work description to make other inferences about work content. For example, the “@” symbol (used to reference another technician or client) could be used by the AI system to look up the types of work that the referenced user regularly services (or requests). Alternatively, the system may look for any “#” symbols within the task text. This symbol allows a user to attach “tags” to the task and provides another metric for the AI system to determine its certainty about a task's content.

Task identification intelligence may also suggest additions or amendments to the current task request that the system ‘thinks’ will make the task align with a given problem space. This may include rewording the title or adding extra information to the description such as the model number of a device if it can ascertain that the task relates to the replacement of physical hardware.

Finally, as part of Task Identification, the Task Duration Estimation Module 132 is responsible for providing an estimated time to complete the work. This value, much like task content, is inferred from a combination of, the average completion time for technicians of similar tasks within a given threshold of certainty and whether the work can be completed remotely or on site.

The Task Content Identification Module 131 may also use geolocation data, or other external data, to calculate estimated travel times between a technician's previous task or work premises to the target site if required. The system differentiates travel time from work time to ensure future estimates of similar work are accurate. In a form where geolocation is required embodiments of the invention may consume third party services to provide accurate real time data and estimates such as Google Maps. Similarly, if special tools are required, the system may prompt the technician to source or bring the required tools or materials.

Once the AI Module 130 has accurately identified the task, the Skills-Based Task Routing Module 133 uses an algorithm to accurately and quickly find a suitable match, or matches, of technicians who are likely to be capable of completing the given Task. A technician's skill is measured by the number of tasks they have closed successfully, how many tasks they have closed where the content of the task matches, within a given threshold, the type of work offered in the current task, the end user's opinion of the technicians and peer reviews of that technicians work or a combination of these parameters.

The Skills-Based Task Routing Module 133 may also consider user preferences. These preferences may include how often a client has engaged with a technician or their given organisation, or whether the client has opted out of working with a subset of the organisations or technicians using the invention.

The AI Module 130 then tracks the completion of tasks, successful or otherwise which informs future requests to the Skills-Based Task Routing Module 133 using machine learning. For example, if an end user consistently reopens tickets completed by a specific technician then the AI Module 130 may infer poor skills in the given task content type and adjust the technician's skill matrix appropriately. However, if a ticket continues to be re-opened automatically by a third party automated system the AI Module 130 may instead recognise this as a recurring task and adjust the technician's skills matrix accordingly to highlight their willingness to work on tickets from said automated system.

FIG. 4 illustrates the general flow of the Task Correlation Module 134. The AI Module 130 cross references the current task content with tasks containing similar content. The system of finding correlated work is similar to the steps required for task content identification. However, unlike task content identification, where the AI Module 130 is comparing the semantic content of a given task, the Task Correlation Module 134 must also consider other factors.

In addition to identifying if a given task contains similar work, the Task Correlation Module 134 must also be able to determine if the work is for the same client, or a different client. The system may infer the relationship between tasks including whether they are a child, sibling, parent or the same item of work being reopened because it was incorrectly resolved in a previous task. This correlation is facilitated by looking at the history of tasks that have content within a prescribed threshold of similarity, closeness to client or technician or follow a linear progression over time.

Task correlation is an important component of the Machine Learning algorithm because it addresses two areas of task management that become time and cost ineffective when completed manually. By allowing the system to either automatically, or manually through worker/end user interaction, link tasks together it becomes much harder for work to get “lost” in the system. Linking tasks also provides the ability for the system to notify users if it believes work is consistently being prematurely closed, not properly resolved or recurring to the extent that the work may be symptomatic of an unidentified root cause.

In a preferred embodiment, the system allows for scheduling of tasks to occupy up to 60% of a given workday. This allows for 40% of the workday to be occupied by unforeseen work, emergency work, or to provide allowances for tasks where the initial time estimate was incorrect. This value is a default and can be modified by the system administrator or by an automated means to optimise the efficiency and workload of workers. The value can be adjusted for each technician by the AI if it determines above or below average performance.

Tables 3 and 4 illustrate the ability of a worker to complete a combination of up to ten “some-time today” tasks or scheduled tasks. A “some-time today” is, a task which requires up to ten minutes but can be done at any point throughout the day. This may include follow up calls to a client, checking logs or service health from a ticket generated automatically by another system, or performing small administrative work. Or in lieu of “some-time today” tasks, a technician may instead schedule several tasks that fulfil the same time requirement.

TABLE 4
Example of day filled with scheduled tasks

Scheduled Task 1
Scheduled Task 2
Scheduled Task 3
Scheduled Task 4
Left Unscheduled (40%)

or

TABLE 3
Example of day filled with some-time today tasks

Some-Time Today Task 1
Some-Time Today Task 2
Some-Time Today Task 3
Some-Time Today Task 4
Some-Time Today Task 5
Some-Time Today Task 6
Some-Time Today Task 7
Some-Time Today Task 8
Some-Time Today Task 9
Some-Time Today Task 10
Left Unscheduled (40%)

The Task Scheduling Module 135 may be responsible for automatically assigning work for tasks wherein the task is automatically created (such as via an IoT device or through a third party system), or wherein a client has no preference on the technician completing the work. In other embodiments, the Task Scheduling Module 135 may be responsible for re-routing tasks to team members who are available to complete tasks in a specific time slot in the event an assigned task needs to be reassigned. It may perform these functions in conjunction with the Skills-Based Task Routing Module 133.

Of important note, a step in any of these processes, whether it arises during task content identification, skills-based task routing, task duration estimation, task correlation or task scheduling; both the requestor of work and the technician have the capacity to override or correct decisions made by any of the associated AI Modules through the end-user's client interface on their Client Device 150. This allows users of the system to feel in-control and make the system responsive to their needs. While the Machine Learning capabilities of the invention abstract the time and cost complexity needed to identify and manage tasks generally, instances will occur when the system is uncertain about its decisions. This may be due to lack of related data or missing data as a result of poor user input.

By being able to update and change tasks as they occur, users provide meaningful points of data for the Machine Learning system to gather better insights to learn from as the system is used over time. This feedback loop in turn provides improved responses to future tasks, which mitigates the need for the end-user to manually make changes.

The user interface of the present system has been designed as a Single Page Application (SPA). When a worker is logged into the platform all primary functions occur in the main view. In some cases, such as for the input of additional information, modal dialogues are displayed to provide a new context for users to enter information.

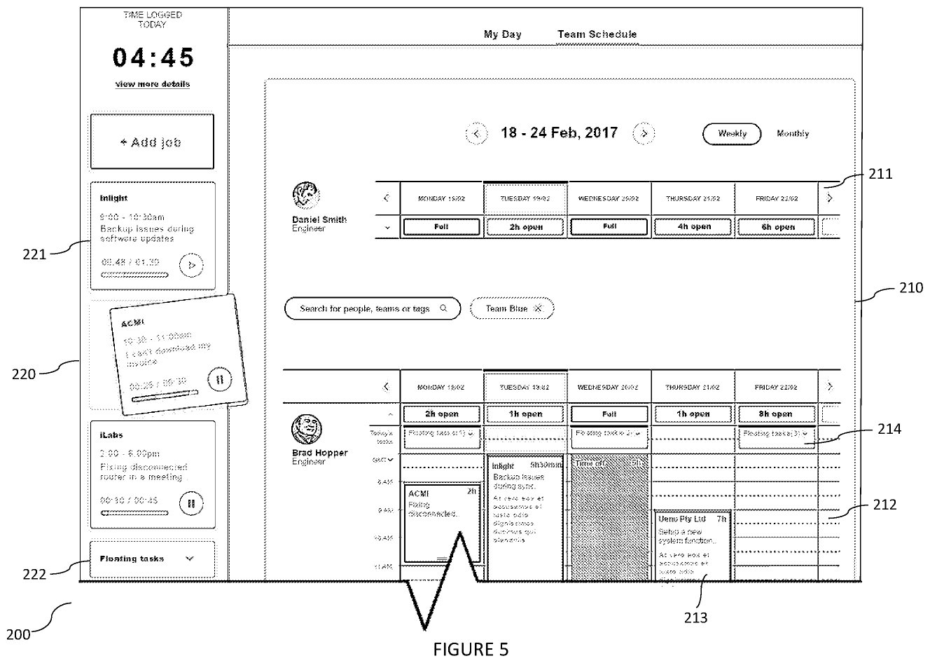

FIG. 5 illustrates the worker view showing the means by which a worker can “drag” a given task into an “active panel” where the system automatically tracks the time taken to complete the task. The system is capable of tracking multiple tasks at once if some Jobs are running concurrently and require simultaneous tracking.

The Worker View 200 exemplified in FIG. 5 shows the side-by-side configuration of a Schedule Allocation Interface 210 and Active Task Interface 220 of embodiments of the invention. The active task interface functions as a “peg board” where a worker can store tasks which have the focus of the worker as either a reminder to begin a task, or to track the active commencement of a task.

The Active Tasks 221 stored in the peg board can be either scheduled tasks or Some-Time Today Tasks 222, which in some embodiments may automatically add to the peg board as the scheduled day or start time is reached, or may be manually added to the peg board by the worker as required by a drag-and-drop input motion from the Task Allocation Interface 210 to the Active Task Interface 220.

The Schedule Allocation Interface 210 can be configured to display individual and team calendars. FIG. 5 exemplifies a team schedule of which a First Team Member's Calendar 211 is collapsed, while a Second Team Member's Calendar 212 is expanded. This allows the user to see the Second Worker's Scheduled Tasks 213 and an overview of the Second Worker's Some-Time Today Tasks 214, which may be further expanded to see the details thereof.

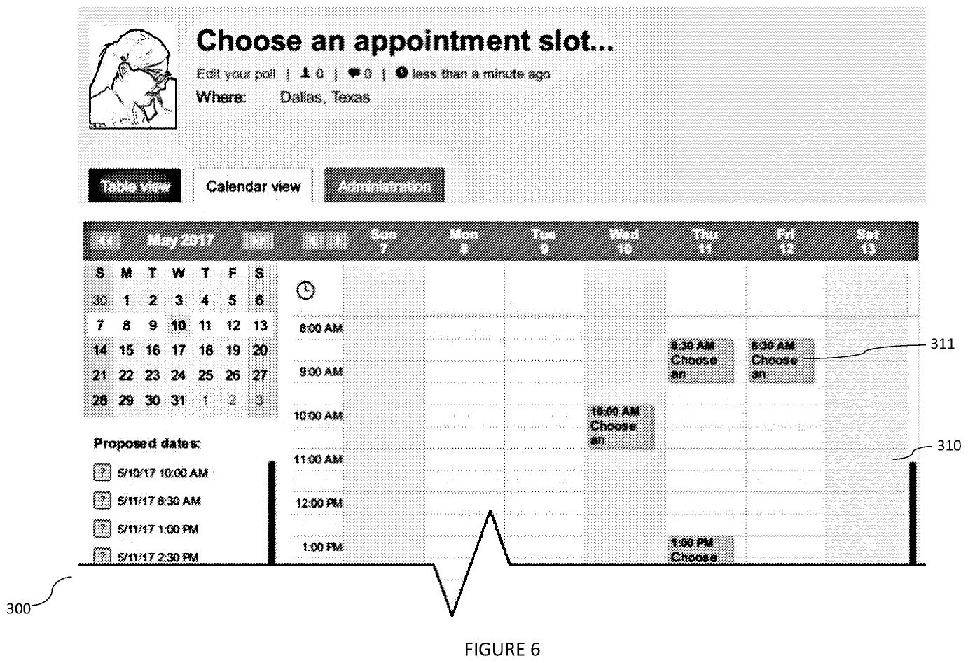

FIG. 6 illustrates an example Client View 300 comprising a Schedule Availability Interface 310 according to embodiments of the invention, which allows clients to select an Available Time 311 for a given worker or selection of workers to complete work. This interface is AI supported and is configured to schedule not only worker availability but also their current workload to ensure that they are not over or underutilised.

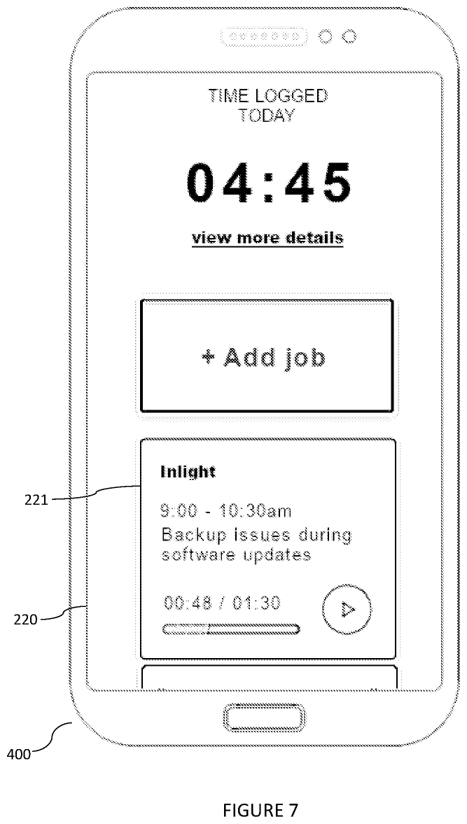

FIG. 7 illustrates an example Mobile View 400 which comprises at least the Active Task Interface 220 for smart devices wherein the active time tracking and management of the Active Tasks 221 of the worker can continue away from the office.

The Mobile View 400 may further comprise the Schedule Availability Interface 310 and/or the Schedule Allocation Interface 210, and further interfaces which are specifically to utilise the functionality of the mobile smart device.

### ‘Help Desk’ Use Case

The following describes a use case for scheduling tasks in the IT industry.

A customer requiring support to install a new printer opens the scheduling system in a web browser, provides sign-in information to commence the service, and types in “printer installation”. The customer provides further detail about the printer to be installed in a text box prompt in plain language.

The AI Module 130 detects that customer's needs are site based, their office is rural, and their office is two hours away from the service centre. The system also recognises that similar printers have been installed quickly for this customer in the past. Due to the required travel time the system allocates four and a half hours, and displays the content of the work further showing some similar work, determined as being related, that the customer can choose (or not) to also adopt.

The customer is shown a list of available time slots that will accommodate a four and a half hour task and lists appropriate IT professionals to complete the work. They select a slot and IT professional they are comfortable with, and the appointment is confirmed. The IT professional is also advised by the system and has an opportunity to interact with the appointment. They are advised to take a range of cables and a ream of paper for connecting the printer.

Both the IT professional and customer receive alerts as the appointment approaches. The IT professional's team receives an alert when the IT professional starts the work, arrives at the customer site, and completes the work.

The time tracking data for the appointment is then sent to a billing module and the service is invoiced at the agreed rate.

### ‘Health Worker’ Use Case

The following describes a use case scheduling work in the medical industry.

A customer has a pain in their abdomen. They use the scheduling system, and type in “stomach pain”, and add some details in plain language. The system asks the customer to identify additional symptoms which might be related, descriptive terms about the symptoms, and locate the symptoms on their body. From these it determines the customer requires an urgent appointment, but only requiring a 15-minute consultation.

The customer is shown three appointment slots of 15 minutes duration that same day and the names of appropriately specialised doctors. The patient selects an appointment slot and a doctor they are comfortable with and leaves for their appointment immediately. The doctor is also advised and can see they may have a patient with appendicitis, and several standard checklist items have been added to the task to ensure that a comprehensive differential diagnosis is completed.

Once the appointment is completed, the system uses the actual time to either offer earlier time slots to subsequent patients if the schedule is ahead of where it is planned to be, or advise subsequent patients of delays if the schedule is behind where it is planned to be.

### ‘One-Off Contractor’ Use Case

The following describes a use case for scheduling work with a one-off contractor.

A customer requiring a room of their home to be painted opens the scheduling system through a third-party software application on their mobile device, provides sign-in information to commence the service, and types in “room painting”. The customer provides further detail about the room in a text box prompt in a plain language description.

The AI Module 130 detects that painting of other “small” rooms took approximately four hours. The system therefore allocates five hours in case of problems and provides the customer with a list of tasks which were required after previous painting jobs. The customer is then able to select any further work which they can adopt.

The customer is shown a list of time slots that will accommodate a five hour task and they are able to select their preference. The system finds appropriately skilled contractors and notifies them of a potential task which they can then quote a price for. The customer is then presented with a list of each contractor which has chosen to quote, and their quoted price. The customer can interact with each of the contractors and once satisfied with the contractor's level of skill and quoted price can select a quote to accept.

The contractor then tracks their time on the task through the scheduling system and once complete, closes the task for invoicing to the customer.

### ‘Taxi Service’ Use Case

The following describes a use case for scheduling a trip with a taxi service.

A customer requiring an immediate pick up opens the scheduling system through a third-party software application on their mobile device, provides sign-in information to commence the service, and provides the system with a pick up address, a drop off address, the detail that it is to be scheduled as soon as possible, and the further plain text comment that they have luggage with them.

The AI Module 130 calculates that the time from pick up to drop off is an hour, and limits potential drivers to those with a vehicle suitable for luggage and within fifteen minutes' drive of the pick-up location. The system then offers these drivers the task and awaits an acceptance.

Once a driver has accepted the task the system tries to insert the hour and fifteen minute task into the schedule and finds another task scheduled for forty-five minutes later. The system automatically reallocates this task to another driver with a clear schedule for that period and awaits their acceptance.

The customer receives alerts as the pick-up approaches and as the driver begins the pick-up they begin the time tracking through the scheduling system.

Once the trip is completed, the customer is charged based on a fixed rate and the time recorded.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

While the invention has been described above in terms of specific embodiments, it is to be understood that the invention is not limited to these disclosed embodiments. Upon reading the teachings of this disclosure many modifications and other embodiments of the invention will come to the mind of those skilled in the art to which this invention pertains, and which are intended to be and are covered by both this disclosure and the appended claims.

It is indeed intended that the scope of the invention should be determined by proper interpretation and construction of the appended claims and their legal equivalents, as understood by those skilled in the art relying upon the disclosure in this specification and the attached drawings.

1. A scheduling system for scheduling a first task to an available resource having an available resource schedule defined by a first resource identification parameter and a first resource temporal parameter comprising;
a resource database configured to store data values associated with one or more resource schedules including at least a first resource identification data value associated with the first resource identification parameter and a first resource temporal data value associated with the first resource temporal parameter,
a task database configured to store data values associated with a first task including at least a first task identification data value associated with a first task identification parameter and a first task temporal data value associated with a first task temporal parameter,
a schedule availability interface for relating the task to the available resource wherein the schedule availability interface is configured to;
communicate a resource availability status for the one or more resource schedules comprising at least the first resource identification data value, the first resource temporal data value and one or more further resource temporal data values,
enable the creation of the first task in the task database by an input of the first task temporal data value associated with the first task temporal parameter received from the schedule availability interface, and
enable the modification of the first task in the task database by an input of a data value associated with the first task temporal parameter received from the schedule availability interface,
a schedule allocation interface for allocating the first task to the available resource wherein the schedule allocation interface is configured to;
display a resource availability status for the available resource schedule displaying the first resource temporal data value associated with the first resource temporal parameter and a second resource temporal data value associated with a second resource temporal parameter,
enable the modification of the first task in the task database by an input of a data value associated with the first task temporal parameter received from the schedule allocation interface, and a communication of the data value to the task database, and
enable the allocation of the first task to an available resource by an input of a data value received from the schedule allocation interface, and a communication of the data value to the task database,
an active task interface for tracking the temporal progression of an allocated task in-progress, wherein the active task interface is configured to;
enable the creation or modification of one or more active task progression temporal data values associated with an active task progression temporal parameter, and communicate the one or more data values to the task database,
reference the one or more task progression temporal data values with the first task identification data value within the task database, and
display the one or more active task progression temporal data values of the one or more tasks in-progress,
wherein a first view comprises the schedule allocation interface and the active task interface in a single display.

2. A scheduling system according to claim 1, wherein the first view comprises a schedule allocation interface and an active task interface characterised wherein:
the schedule allocation interface comprises a resource calendar for the resource displaying;
regular time intervals wherein the resource availability status between each time interval is displayed as available or unavailable, and
the first resource temporal data value and the second resource temporal data value which define a time interval in the resource calendar,
a first allocated task is displayed in the resource calendar across a time interval defined by;
the first task temporal data value corresponding with a start time for the task, and
a second task temporal data value corresponding with an end time for the task, and
occupying all time intervals in the resource calendar therebetween, and
the active task interface comprises a display of tasks in-progress which include,
one or more tasks associated with task temporal data values corresponding with a past start time for the task and a future end time, and
one or more tasks associated with task temporal data values corresponding with a future start time and one or more active task progression temporal data values created from a user input via the active task interface,
wherein the schedule allocation interface and the active task interface are linked to enable a user to dynamically create or modify one or more active task progression temporal data values with a single end user input.

3. A scheduling system according to claim 2, wherein the schedule allocation interface displays at least one sub-calendar configured to display one or more tasks sharing a common temporal data value.

4. A scheduling system according to claim 2, wherein the schedule allocation interface is configured to display a resource availability status for multiple resources whereby:
the schedule allocation interface comprises a resource calendar for the multiple resources displaying set time intervals wherein the resource availability status for each or all resources at a time interval is displayed as available or unavailable.

5. A scheduling system according to claim 1, configured for viewing on a mobile device display, comprising a second view having a graphical user interface wherein the schedule allocation interface and the schedule availability interface are reduced or hidden, and the active task interface is displayed in the graphical user interface.

6. A scheduling system for scheduling a first task to an available resource having an available resource schedule defined by a first resource identification parameter and a first resource temporal parameter comprising;
a resource database configured to store data values associated with one or more resource schedules including at least a first resource identification data value associated with the first resource identification parameter and a first resource temporal data value associated with the first resource temporal parameter,
a task database configured to store data values associated with a first task including at least;
a first task identification data value associated with a first task identification parameter,
a first task temporal data value associated with a first task temporal parameter, and
a first task request data value associated with a first task request parameter,
a schedule availability interface for relating the task to the available resource wherein the schedule availability interface is configured to;
communicate a resource availability status for the one or more resource schedules comprising at least the first resource identification data value, the first resource temporal data value and one or more further resource temporal data values,
enable the creation of the first task in the task database by an input of the first task temporal data value associated with the first task temporal parameter and the first task request data value associated with a first task request parameter, received from the schedule availability interface, and
enable the modification of the first task in the task database by an input of a data value associated with the first task temporal parameter received from the schedule availability interface,
a schedule allocation interface for allocating the first task to the available resource wherein the schedule allocation interface is configured to;
display a resource availability status for the available resource schedule displaying the first resource temporal data value associated with the first resource temporal parameter and a second resource temporal data value associated with a second resource temporal parameter,
enable the modification of the first task in the task database by an input of a data value associated with the first task temporal parameter received from the schedule allocation interface, and a communication of the data value to the task database, and
enable the allocation of the first task to an available resource by an input of a data value received from the schedule allocation interface, and a communication of the data value to the task database,
an active task interface for tracking the temporal progression of an allocated task in-progress, wherein the active task interface is configured to;
enable the creation or modification of one or more active task progression temporal data values associated with an active task progression temporal parameter, and communicate the one or more data values to the task database,
reference the one or more task progression temporal data values with the first task identification data value within the task database, and
display the one or more active task progression temporal data values of the one or more tasks in-progress,
wherein a first view comprises the schedule allocation interface and the active task interface in a single display.

7. A scheduling system according to claim 6, wherein the schedule availability interface comprises a display enabled to create or modify the first task in the task database by an input of a categorised data value.

8. A scheduling system according to claim 6, wherein the task database is configured to;
store a set of historical task data values comprising one or more historical task request data values associated with a first task request parameter,
reference a first task request data value associated with a first task request parameter with the one or more historical task request data values associated with a first task request parameter, and
communicate the one or more historical task request data values with the schedule allocation interface wherein information of the one or more historical task request data values is displayed by the resource allocation interface.

9. A scheduling system according to claim 8, wherein the task database is configured to modify a first task request data value to categorise and associate the modified data value with a first task request parameter.

10. A non-transitory computer readable storage medium having stored an artificial intelligence engine for a scheduling system according to claim 8 and having a task processing artificial intelligence module configured to;
receive a task request from the schedule availability interface, and
process the request to generate a first task request data value,
wherein the artificial intelligence engine is configured to process the task request to generate a first task request data value.

11. A non-transitory computer readable storage medium according to claim 10, wherein the task processing artificial intelligence module comprises a natural language processing tool.

12. A scheduling system for scheduling a first task to an available resource having an available resource schedule defined by a first resource identification parameter and a first resource temporal parameter comprising;
a resource database configured to store data values associated with one or more resource schedules including at least;
a first resource identification data value associated with the first resource identification parameter,
a first resource temporal data value associated with the first resource temporal parameter, and
a first resource capability data value associated with a first resource capability parameter,
a task database configured to store data values associated with a first task including at least a first task identification data value associated with a first task identification parameter and a first task temporal data value associated with a first task temporal parameter,
a schedule availability interface for relating the task to the available resource wherein the schedule availability interface is configured to;
communicate a resource availability status for the one or more resource schedules comprising at least the first resource identification data value, the first resource temporal data value and one or more further resource temporal data values,
enable the creation of the first task in the task database by an input of the first task temporal data value associated with the first task temporal parameter received from the schedule availability interface, and
enable the modification of the first task in the task database by an input of a data value associated with the first task temporal parameter received from the schedule availability interface,
the resource database further configured to;
filter or prioritise multiple resources according to their resource temporal data values associated with their resource temporal parameters and their capability data values associated with their capability parameters, according to preferences or criteria pre-set within the database or preferences or criteria selected from the schedule availability interface,
communicate a resource availability status for the filtered or prioritised resources each comprising at least one resource identification data value and two or more resource temporal data value and one or more further resource temporal data values
a schedule allocation interface for allocating the first task to the available resource wherein the schedule allocation interface is configured to;
display a resource availability status for the filtered or prioritised resources displaying the first resource temporal data value associated with the first resource temporal parameter and a second resource temporal data value associated with a second resource temporal parameter,
enable the modification of the first task in the task database by an input of a data value associated with the first task temporal parameter received from the schedule allocation interface, and a communication of the data value to the task database, and
enable the allocation of the first task to an available resource by an input of a data value received from the schedule allocation interface, and a communication of the data value to the task database,
an active task interface for tracking the temporal progression of an allocated task in-progress, wherein the active task interface is configured to;
enable the creation or modification of one or more active task progression temporal data values associated with an active task progression temporal parameter, and
communicate the one or more data values to the task database,
reference the one or more task progression temporal data values with the first task identification data value within the task database, and
display the one or more active task progression temporal data values of the one or more tasks in-progress,
wherein a first view comprises the schedule allocation interface and the active task interface in a single display.

13. A scheduling system according to claim 12, wherein the resource database configured to store data values associated with the one or more resource schedules further includes at least;
a first resource identification data value associated with the first resource identification parameter,
a first resource temporal data value associated with the first resource temporal parameter,
a first resource capability data value associated with a first resource capability parameter, and
a first resource feedback data value associated with a first resource feedback parameter,
and the resource database is further configured to;
filter or prioritise multiple resources according to their resource feedback data value associated with a first resource feedback parameter and resource temporal data values associated with their resource temporal parameters and their capability data values associated with their capability parameters, according to preferences or criteria pre-set within the database or preferences or criteria selected from the schedule availability interface.

14. A scheduling system according to claim 12 wherein the schedule availability interface and the schedule allocation interface are configured to rank or weight;
preferences or criteria pre-set within the database, or
preferences or criteria selected from the schedule availability interface to prioritise the scheduling of resources with preferred resource data values associated with selected resource parameters.

15. A scheduling system according to claim 14, wherein the selected resource parameters comprises a resource feedback parameter including any one of; the time taken for completion of the task, number of times a task has been reopened, a satisfaction score, number of the same or similar tasks previously completed, or any combination thereof.

16. A non-transitory computer readable storage medium having stored thereon an artificial intelligence engine for a scheduling system according to claim 14 having a resource processing artificial intelligence module configured to;
prioritise the scheduling of resources with preferred resource data values associated with selected resource parameters,
communicate one or more prioritised resource schedules to the schedule allocation interface, and
receive resource feedback data values to modify the resource processing artificial intelligence module.

17. A non-transitory computer readable storage medium according to claim 14, wherein the task database is configured to store data values associated with a first task including at least;
a first task identification data value associated with a first task identification parameter,
a first task temporal data value associated with a first task temporal parameter, and
a first task request data value associated with a first task request parameter, wherein the first task request data value is categorised and referenced to any one of a resource identification data value, resource temporal data value, resource capability data value or a resource feedback data value.

18. A scheduling system according to claim 17, wherein the schedule availability interface comprises a display enabled to create or modify the first task in the task database, by an input of a categorised data value, and referenced to any one of a resource identification data value, resource temporal data value, resource capability data value or a resource feedback data value.

19. A scheduling system according to claim 17, wherein the artificial intelligence engine comprises a task processing artificial intelligence module configured to;
receive a task request from the schedule availability interface, and
process the request to generate a first task request data value,
wherein the artificial intelligence engine is configured to process the task request to generate a first task request data value that is categorised and referenced to any one of a resource identification data value, resource temporal data value, resource capability data value or a resource feedback data value.
